(19) United States
(12) Patent Application Publication
(10) Pub. No.: US 2011/0211956 A1
(43) Pub. Date: Sep. 1, 2011

(54) PARALLEL-CONNECTED MATRIX INTEGRATED WIND POWER GENERATION SYSTEM

(76) Inventor: Chin-Lien TSENG, ChuPei City (TW)

(21) Appl. No.: 13/033,141

(22) Filed: Feb. 23, 2011

(30) Foreign Application Priority Data
Feb. 26, 2010 (TW) 099105712

(51) Int. Cl. F03D 7/06

(52) U.S. Cl. 416/9

(57) ABSTRACT

A parallel-connected matrix integrated wind power generation system, which includes: a plurality of Savonius wind turbines and a plurality of phase angle positioning components among wind turbines and a plurality of distance positioning components among wind turbines; meanwhile, the phase angle positioning components among wind turbines also have the function to transfer the mechanical energy of wind turbine, and the plurality of Savonius wind turbines are arranged in parallel way; the distance positioning components among wind turbines are connected to those plurality of Savonius wind turbines so that fixed distances are maintained among the plurality of Savonius wind turbines; moreover, the phase angle positioning components among wind turbines are connected to the plurality of Savonius wind turbines so that fixed phase angle differences are maintained among the plurality of Savonius wind turbines; furthermore, Savonius wind turbine of this system is further installed with flow-guiding plate, and the structural cross-section of flow-guiding plate is in between Clark Y and NACA 0015, which is calculated and decided according to real wind field CFD; furthermore, the flow-guiding plate can be used to adjust the force taken by different phase angle of the plurality of Savonius wind turbines, which is helpful to the enhancement the space utilization efficiency of wind field and the reinforcement of energy collection efficiency of wind power, that is, the wind power generation efficiency of integrated wind power generation system of a plurality of Savonius wind turbines can be greatly enhanced; moreover, this system is also applicable to parallel-connected and integrated wind power generation system that modifies Savonius wind turbine from two-bladed type to three-bladed type or multi-bladed type wind turbine.

### FIELD OF THE INVENTION

The present invention relates to a parallel-connected matrix integrated wind power generation system, it specifically to an integrated wind turbine formed by a plurality of parallel-connected and arranged Savonius wind turbines, meanwhile, among a plurality of Savonius wind turbines, a plurality of flow-guiding plates can, a plurality of phase positioning component among wind turbines and a plurality of distance positioning components among wind turbines can be added so that when wind flows in, a plurality of Savonius wind turbines connected to the integrated wind turbine will then move along with the wind in the fixed distance and phase angle difference; it not only can effectively enhance the utilization efficiency of wind field space and reinforce the collection efficiency of wind power energy, but also can enhance the entire optimal synergy of integrated wind turbine and greatly enhance the entire wind power generation efficiency, which is very different than the prior art wind power generation system that purely pursues the optimal efficiency of single wind turbine.

### BACKGROUND OF THE INVENTION

Sufficient energy and power is the key push-hand of the progress of an era! Facing with the extreme risk of energy shortage and power insufficiency, lots of the countries have to find new energy aggressively. Moreover, to slow down the global warming risk due to green house effect, the entire globe has started actions such as: preparation and signing of Kyoto Protocol, internal regulation and law of each country and the regulatory requirement of each local market, that is, all the new energy development requirement and utilization condition and standard have been promoted to the level of green energy that can be in sustaining development. Therefore, clean, non-polluted and technologically mature and renewable wind power generation has become no doubt one of the best solutions of such type of green energies.

Wind power generation can be defined as the use of wind turbine to collect wind energy and convert it into rotational kinetic energy, which in turn pushes the power generator to generate electrical energy. If we classify according to the appearance of wind power generation, wind turbine can be briefly divided into horizontal axis wind turbine (HAWT) with rotational axis parallel to the wind direction and vertical axis wind turbine (VAWT).

After long term of development and practical application experiences, which of these two types of wind power generations is winner is settled down; currently, the main stream of wind power generation is no double HAWT. For example: large scale three-bladed wind power generator that is scattered everywhere on Taiwan's seashore is one type of HAWT generator with wide application.

Due to the correlation between the axial direction and blade shape in HAWT power generator, the wind power generation efficiency of each HWAT power generator can reach an average Cp of about 0.30-0.45, which is pretty ideal power generation efficiency.

Cp=P/(ρAU₁³/2)

(P represents the wind energy acquired by wind turbine, p means air density, A means the wind-taking area of wind turbine, U means the wind speed)

For VAWT power generation, the average Cp value reached can only be 0.15-0.30, as a comparison, the wind power generation efficiency of HAWT is significantly higher than that of VAWT.

However, the high peripheral speed ratio of HAWT wind power generation makes blade speed much larger than the wind speed, which leads to low frequency wind cut noise, moreover, since the blade rotation of HAWT wind power generation system will form wind field of certain range, hence, fixed space must be maintained between each HAWT wind turbine so as to avoid the interference from wind field, or it might even lead to the malfunction and damage of wind turbine.

In addition, in order to get good power generation efficiency of HAWT wind turbine, wind turbine angle must be adjusted according to the wind direction, once the wind-facing angle that needs to be adjusted is large, the wind turbine even needs to be stopped with its operation, and the bulky wind turbine machine set even needs to be changed in its direction, finally, it should be started again for its operation, and the entire process might take about 1-2 hours. To sum up, we know that HAWT wind power generation usually can only be set up at location with large space and with stable wind direction, for example, seashore and plateau, etc.

To set up bulky wind turbine machine set at large space that is rarely reached by people and with stable wind direction, it also means the high cost and expenditure. From the one time construction cost of land preparation, the installation of power generation machine set, installation of wind turbine system, to the continuous expenditure of daily operation, adjustment and maintenance and repair, according to the statistic, the average cost of each HAWT wind power generation system is as high as several hundreds millions NT dollars.

Moreover, for HAWT wind power generation, to get economic effectiveness, usually more than one wind power generation wind turbines are installed in the selected and suitable wind field area, however, since HAWT wind turbine must be adapted to the operation characteristic of wind direction, usually each HAWT wind turbine must be accompanied with one power generation machine set, hence, the entire setup and subsequent maintaining cost of HAWT wind power generation wind turbine system is pretty high.

High setup cost, setup space and site limitation makes people to think about and examine the feasibility of using VAWT wind power generation. At this moment, (Darrieus) and φ-Darrieus are gradually used in the city street and the peripherals of building due to its not bad power generation efficiency (Cp value can be 20-30%), simpler system and relatively low installation cost. For example, new design patent D115854 and D115855 of Republic of China and utility model patent M312834 of R.O.C.

As compared to the attention and new improvement and application of Darrieus wind turbine as invented by French aviation engineer in 1931, the luckiness of Savonius wind turbine as designed and developed as early as 1922 by Finland engineer is much worse. Although the structural simplicity and low cost of Savonius wind turbine is not inferior to Darrieus wind turbine, yet its lower power generation efficiency Cp (general mean value is about 15-20%) is the main cause that Savonius wind turbine still can not be used again by the industry.

Therefore, the inventor of the present invention, to avoid the utilization drawbacks and application limits of the above mentioned existed wind turbine power generation and traditional Savonius wind turbine, thus spend lots of time in the theoretical application and long time of mechanism planning and practical development to propose integrated wind power generation system that has its main body based on a plurality of Savonius wind turbines, through a plurality of parallel-connected and arranged Savonius wind turbines, an integrated wind turbine is formed, meanwhile, among a plurality of Savonius wind turbines, it is added with a plurality of flow-guiding plates or a plurality of positioning components so that when the wind flows in, the plurality of Savonius wind turbines connected to the integrated wind turbine will move along with the wind in fixed distance and phase angle, hence, it can effectively enhance the utilization efficiency of wind field space and reinforce the collection synergy of wind energy, that is, the entire Savonius wind turbine wind power generation efficiency can be greatly enhanced, and it is thus a reasonable invention that can enhance the synergy of the above mentioned event.

### SUMMARY OF THE INVENTION

One objective of the present invention is to provide a parallel-connected matrix integrated wind power generation system so that when wind flows in, a plurality of Savonius wind turbinewind power generation system can move along in fixed distance and phase angle, and the entire wind power collected by a plurality of Savonius wind turbines will add to each other, that is, the synergy can be exploited, and the entire wind power generation efficiency can then be greatly enhanced.

The second objective of the present invention is to provide a parallel-connected matrix integrated wind power generation system so that adjustment can be made according to wind force and wind direction change, hence, a plurality of flow-guiding plates will be associated in each Savonius wind turbine of wind power generation system so that when each Savonius wind turbine is rotating, the wind field will be maintained at the optimal status, that is, the utilization efficiency of wind field space and power generation efficiency is indeed effectively enhanced.

The third objective of the present invention is to provide a parallel-connected matrix integrated wind power generation system, in the wind power generation machine room of wind power generation system, one set of power generation machine set can be used to be corresponded to a plurality of Savonius wind turbines, or multiple power generation machine sets can be used to be corresponded to a plurality of Savonius wind turbines, moreover, it can also be changed according to the strength of the wind force and wind direction, for example, the power generation machine set can be added or released so that the collected wind energy can be effectively utilized, and the cost of installation and maintenance of system's power generation machine set can then be reduced.

To achieve the above first objective, the present invention has proposed a parallel-connected matrix integrated power generation system, which includes: a plurality of Savonius wind turbines, a plurality of positioning components among wind turbines, and a plurality of phas positioning components among wind turbines; meanwhile, those plurality of Savonius wind turbine are arranged in parallel-connected way; the distance positioning components among wind turbines are connected to those plurality of Savonius wind turbines so that fixed distances are maintained among those plurality of Savonius wind turbines; furthermore, the phase angle positioning components among those plurality of wind turbines are connected to those plurality of Savonius wind turbines so that fixed phase angle differences are maintained among those plurality of Savonius wind turbines.

To achieve the above mentioned second objective, the present invention has proposed a parallel-connected matrix integrated wind power generation system, and each individual Savonius wind turbine can be added with plurality of flow-guiding plates, then through those plurality of flow-guiding plates and at different wind field situation formed by different wind force and wind direction, those forces taken by those plurality of Savonius wind turbines at different phase angles can then be adjusted accordingly.

To achieve the above mentioned objective three, the present invention has proposed a parallel-connected matrix integrated wind power generation system, which includes a power generation machine room, and within the power generation machine room, it includes a control module and a plurality of power generation machine sets; the mechanical energies collected by those plurality of Savonius wind turbines are transferred, in transmission axis or transmission chain way, to the power generation machine room, and the control module then follows wind kinetic energy to control the operation of those plurality of power generation machine sets.

For the advantages and spirit regarding the present invention, further understanding can be achieved through the following detailed description and attached drawings of the present invention.

### BRIEF DESCRIPTION OF THE DRAWINGS

FIG. 1 illustrates the first embodiment of this invention.

FIG. 2 illustrates the second embodiment of this invention.

FIG. 3 illustrates the flow-guiding plate of the second embodiment of this invention.

FIG. 4 illustrates the third embodiment of this invention.

FIG. 5 illustrates the flow-guiding plate of the third embodiment of this invention.

FIG. 6 illustrates the fourth embodiment of this invention.

FIG. 7 illustrates the flow-guiding plate of the fourth embodiment of this invention.

FIG. 8 illustrates the fifth embodiment of this invention.

FIG. 9 illustrates the flow-guiding plate of the fifth embodiment of this invention.

FIG. 10 illustrates the sixth embodiment of this invention.

FIG. 11 illustrates the flow-guiding plate of the sixth embodiment of this invention.

### DETAILED DESCRIPTION OF THE INVENTION

In order to let your esteemed examiner be able understand further the technology, means and function taken by this invention to achieve the scheduled objective, please refer to the following detailed description and drawings regarding this invention. We believe that the objective, feature and characteristic of this invention should be able to be understood in depth through here, however, the attached drawing is only for reference and description but not to limit the scope of this invention.

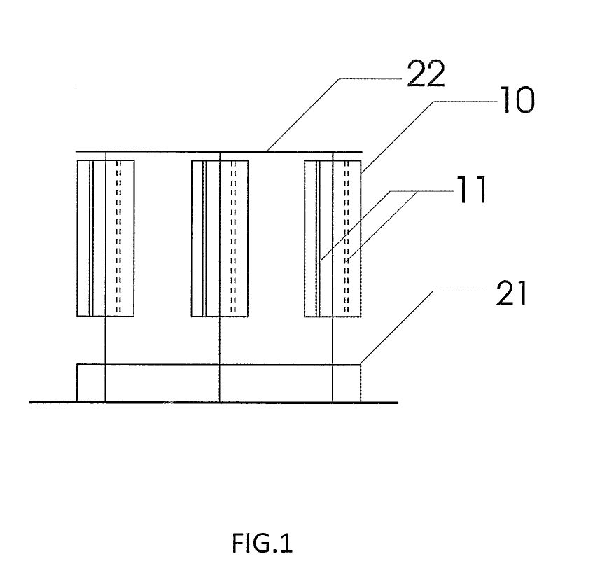

The first embodiment of a parallel-connected matrix integrated wind power generation system of this invention is as shown in FIG. 1, which includes three Savonius wind turbines 10, phase positioning components among wind turbines 21 and distance positioning components among wind turbines 22; moreover, three Savonius wind turbines 10 are arranged in parallel-connected way, and the phase positioning components among wind turbine 21 are connected to three Savonius wind turbines 10 so as to fix phase angle difference between each Savonius wind turbine; the fixing of the phase angle difference between neighboring Savonius wind turbine 10 is helpful to the generation of constructive interference so that the entire effectiveness of multiple parallel-connected wind power generation wind turbines can be enhanced. The distance positioning components among wind turbines 22 are connected to the neighboring Savonius wind turbines 10 so that fixed distance is maintained among Savonius wind turbines 10; among the blades of each Savonius wind turbine 10, it is installed with flow-guiding plate 11, hence, when wind flows in, three Savonius wind turbines 10 connected to the phase positioning components among wind turbines 21 will then move along with the wind, and the energy generated due to the rotation of wind turbine will then, through the phase positioning components among wind turbines 21, be transferred to power generation machine set.

The structural cross-section of flow-guiding plate 11 is in between Clark Y and NACA 0015, which can be decided according to real wind field CFD calculation; meanwhile, flow-guiding plate 11 can be used to adjust the force taken by Savonius wind turbine 10 at different phase angle, which is helpful to the enhancement the utilization efficiency of wind field space and the reinforcement of the collection efficiency of wind power, that is, the entire wind power generation efficiency will be greatly enhanced.

In the following and other embodiment, the distance positioning components among wind turbines 22 can have many different choices, for example, lever and frame, and it is connected to the axis of wind turbine through bearing, or, the distance positioning components among wind turbines can also be connected to the axis of wind turbine 10 through hole punching on a plate, by doing so, the distance between two wind turbines 10 will then be fixed.

In the following and other embodiment, the phase positioning components among wind turbines 21 can be, for example, transmission axis, transmission chain or accompanied gear set. When wind turbine 10 is rotating, it will bring up the action of phase positioning components among wind turbines 21 to generate energy and transfer it to the power generator machine set. In the embodiment of this patent specification, this invention uses phase positioning components among wind turbines to make the phase angle differences among wind turbines 10 stay fixed and to transfer the rotational energy of wind turbine 10 to the power generation machine set. In other embodiment, these two functions can also be realized using two different components, which all fall within the scope of phase positioning components among wind turbines of this invention.

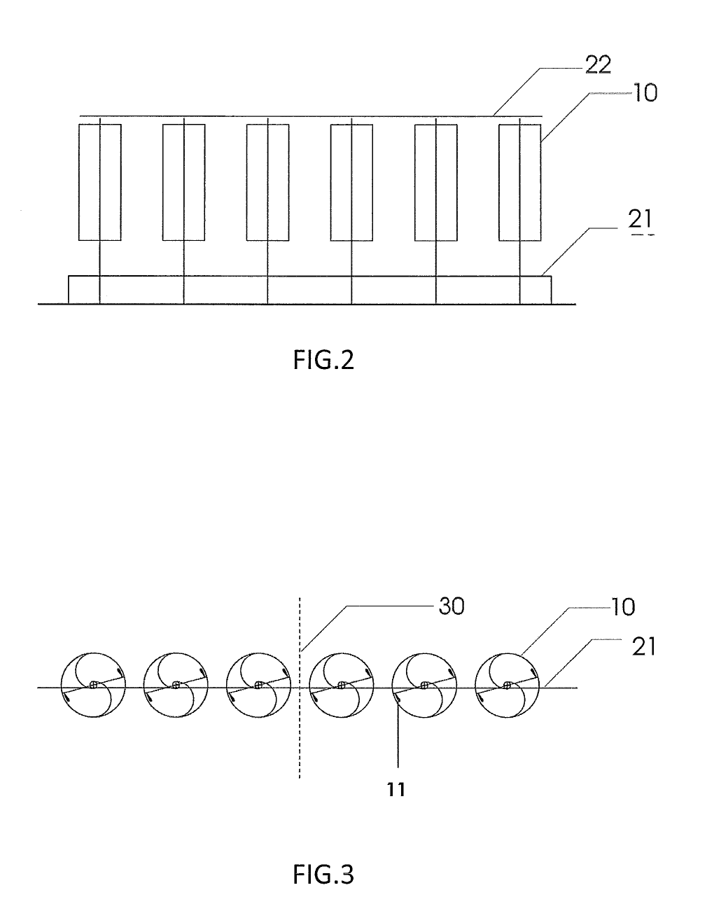

The second embodiment of parallel-connected matrix integrated wind power generation system of this invention is as shown in FIG. 2 and FIG. 3, which includes: six Savonius wind turbines 10 and phase positioning components among wind turbines 21; six Savonius wind turbines 10 are arranged in parallel-connected way, phase positioning components among wind turbines 21 are connected to six Savonius wind turbines 10 so that fixed phase angle differences are maintained among six Savonius wind turbines 10; distance positioning components among wind turbines 22 make six Savonius wind turbines 10 maintain fixed distances; moreover, horizontal connection is not used between support component 30 and distance positioning components among wind turbines 22, one end of support component 30 is connected to the ground or other fixed object so as to provide fixing and support action for entire wind turbine set and to prevent the collapse of wind turbine set. Support component 30 can be, for example, lever, frame, steel rope and pillar, etc. There is no flow-guiding plate 11 between the blades of each Savonius wind turbine 10, hence, when the wind flows in, six Savonius wind turbines 10 connected to phase positioning components among wind turbines 21 will then move along with the wind.

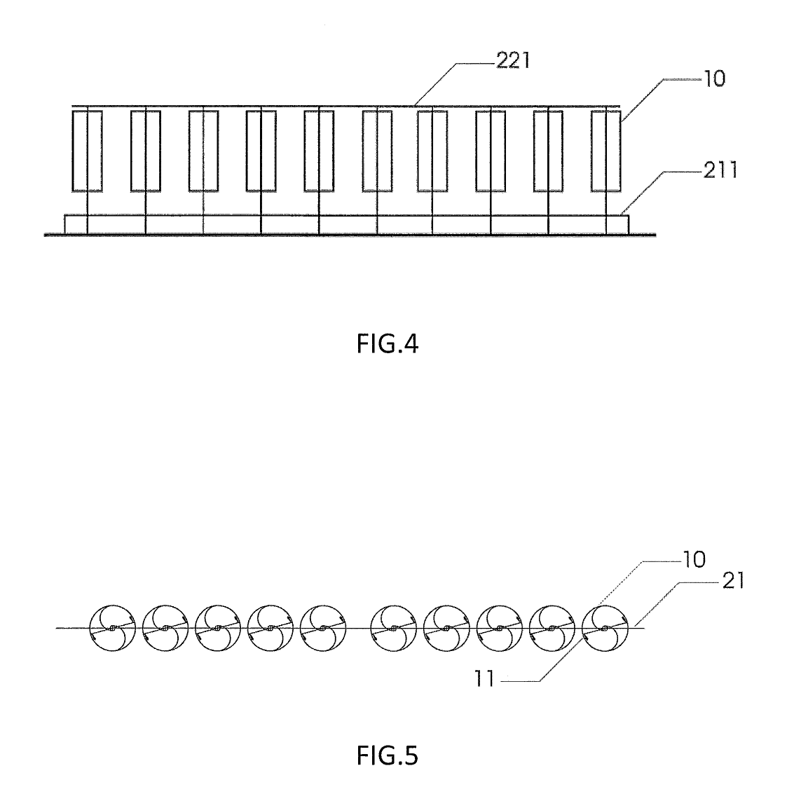

The third embodiment of a parallel-connected matrix integrated wind power generation system of this invention is as shown in FIG. 4 and FIG. 5, which includes: ten Savonius wind turbines 10 and gear sets 211, ten Savonius wind turbines 10 are arranged in parallel-connected way, gear sets 211 are connected to ten Savonius wind turbines 10 and are connected and rotated with ten Savonius wind turbines 10, meanwhile, fixed phase angle differences are maintained among these ten Savonius wind turbines 10, and lever 221 is connected to these ten Savonius wind turbines 10 so that fixed distances are maintained among these ten Savonius wind turbines 10, moreover, there is no flow-guiding plate 11 between the blades of each Savonius wind turbine 10, hence, when wind flows in, ten Savonius wind turbines 10 connected to gear set 211 and lever 221 will then move along with the wind.

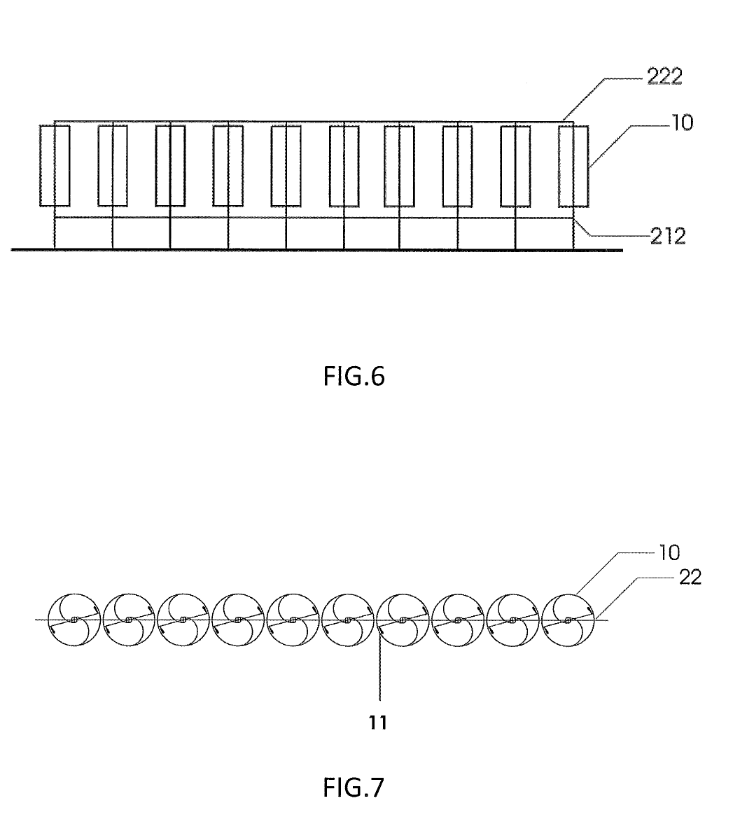

The fourth embodiment of parallel-connected matrix integrated wind power generation system of this invention is as shown in FIG. 6 and FIG. 7, which includes: ten Savonius wind turbines 10 and transmission axis 212, ten Savonius wind turbines 10 are arranged in parallel-connected way, and transmission axis 212 is connected to ten Savonius wind turbines 10 so that the phase angle difference among these ten Savonius wind turbines 10 will remain fixed. Frame 222 is connected to these ten Savonius wind turbines 10 so that fixed distances are maintained among these ten Savonius wind turbines 10; meanwhile, there is flow-guiding plate 11 installed between the blades of each Savonius wind turbine 10, hence, when wind flows in, ten Savonius wind turbines 10 connected to transmission axis 212 and frame 222 will then move along with the wind.

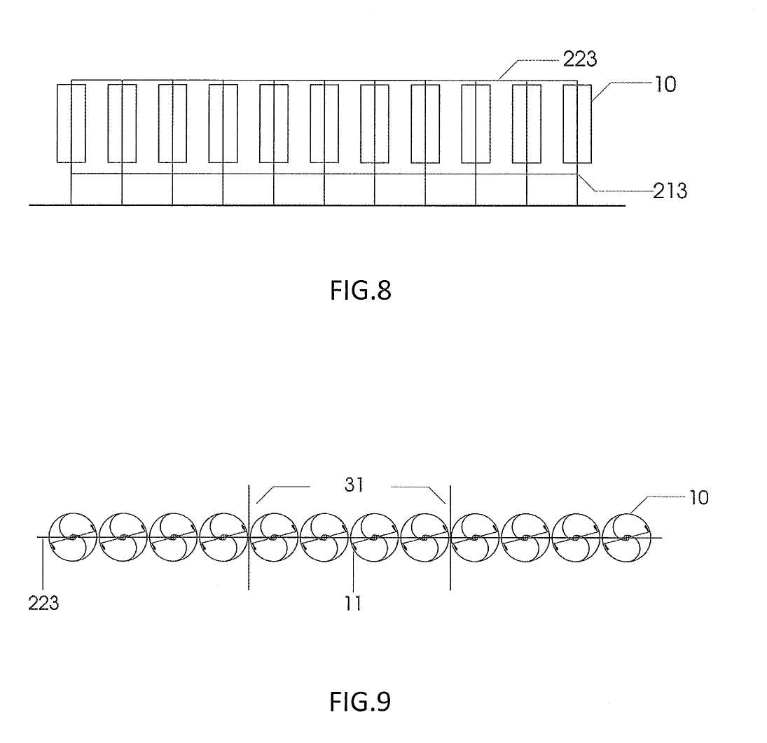

The fifth embodiment of a parallel-connected matrix integrated wind power generation system of this invention is as shown in FIG. 8 and FIG. 9, which includes: twelve Savonius wind turbines 10 and transmission chains 213, twelve Savonius wind turbines 10 are arranged in parallel-connected way, and transmission chains 213 are connected to twelve Savonius wind turbines 10, meanwhile, connection is made to the non-parallel direction of the rotational axis of these twelve Savonius wind turbines 10 so that the phase angle differences among these twelve Savonius wind turbines 10 are fixed; moreover, support lever 31 is connected to plate 223 in non-parallel way so as to provide support and fixing action for the entire wind turbine set. Plate 223 is used to maintain the distances among twelve Savonius wind turbines 10 fixed, and there is no flow-guiding plate 11 between the blades of each Savonius wind turbine 10 of this invention, hence, when wind flows in, twelve Savonius wind turbines 10 connected to transmission chain 213 and plate 223 will then move along with wind.

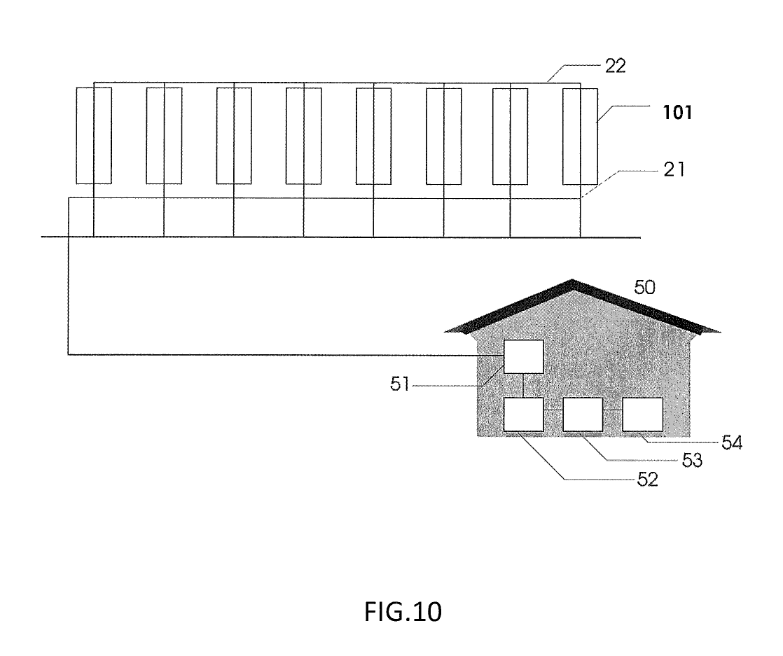

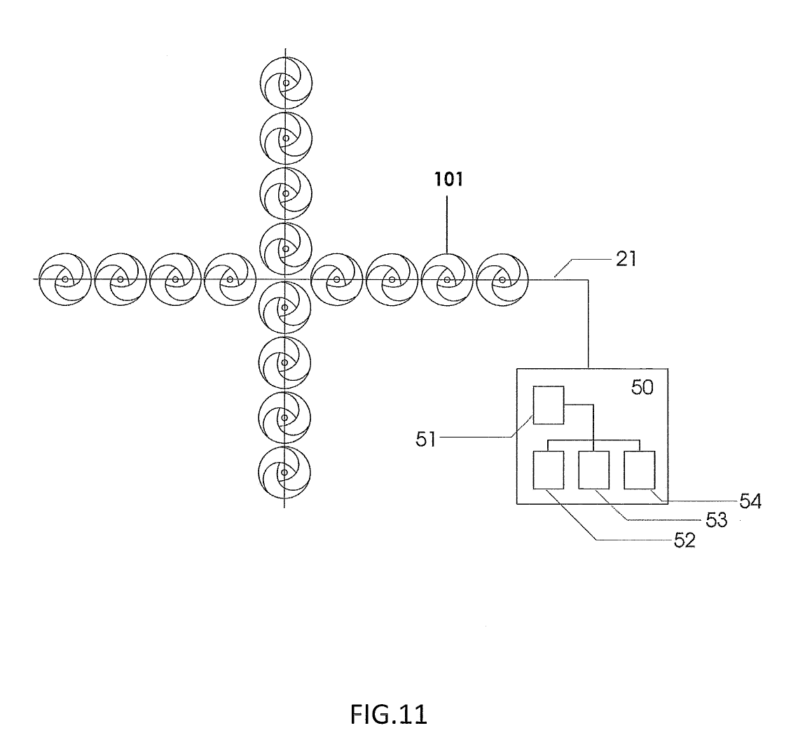

The sixth embodiment of a parallel-connected matrix integrated wind power generation system of this invention is as shown in FIG. 10 and FIG. 11, which includes: 16 improved three-bladed Savonius wind turbines 101 and two phase positioning components among wind turbines 21, meanwhile, each eight improved three-bladed Savonius wind turbines 101 are set up as one set and are arranged in parallel-connected way, each phase positioning components among wind turbines 21 is connected to one set of eight improved three-bladed Savonius wind turbines 101 in the non-parallel direction of the rotational axis direction so as to fix the phase angle differences among eight Savonius wind turbines 101, and distance positioning components among wind turbines 22 make fixed distances remained among eight Savonius improved three-bladed wind turbines 101. From this embodiment, it can be understood that wind turbine set of different combination can be applicable to this invention.

When the wind flows in, the Savonius wind power generation set formed by each phase positioning component among wind turbines 21 and the connected a set of eight Savonius improved three-bladed wind turbines 101 will then move along with the wind, and energy will be generated and converted, transferred and collected.

The above mentioned parallel-connected matrix integrated Savonius wind power generation set collects wind energy and transfers the mechanical energy to power generation machine room 50, meanwhile, energy conversion is done through the first power generation machine set 52 and second power generation machine set 53 of the power generation machine room 50. When wind force increases, control module 51 within power generation machine room 50 will then follow the level of energy increase to control the third power generation machine set 54 to add into the operation in time, and when the wind force decreases, control module 51 will then control the second power generation machine set 53 and the third power generation machine set 54 to release quickly so as to reach good power generation efficiency.

Therefore, this invention can indeed, through the above mentioned disclosed technology, provide a parallel-connected matrix integrated wind power generation system, hence, when wind flows in, those plurality of Savonius wind turbines will then move along with the wind, meanwhile, through a plurality of flow-guiding plates, forces taken by the plurality of Savonius wind turbines are adjusted; moreover, a plurality of distance positioning components among wind turbines and phase positioning components among wind turbines are used to maintain fixed phase angle differences and fixed distances among those plurality of Savonius wind turbines, hence, the utilization efficiency of the wind field space can be effectively enhanced, the wind energy collection synergy can be reinforced too, and finally, the wind power generation efficiency of the entire system can be greatly enhanced.

Anyone who is familiar with the prior art should know that this invention is also applicable to two-bladed type, improved three-bladed type or multi-bladed type Savonius wind turbine.

Furthermore, what is needed to be noticed is, this invention emphasizes on the use of a combination of a plurality of Savonius wind turbines to be used as the main body of wind power generation, which is never disclosed in the field of wind power generation. In the prior art technology, Darrieuswind turbine is the same as Savonius wind turbine, that is, VAWT, and the power generation efficiency is not bad either, but only destructive interference will be generated between two Darrieuswind turbines to reduce the power generation efficiency. Moreover, in this invention, Savonius wind turbine is used, and constructive interference can be generated in the neighboring wind turbine, meanwhile, both the fixed phase difference between neighboring wind turbines of this invention and the flow-guiding plate design are helpful to the enhancement of the entire efficiency of multiple parallel-connected wind power generation wind turbines.

Since Savonius wind turbine is used in this invention, the cost is of course much lower than that of wind power generation system of HAWT wind turbine.

A parallel-connected matrix integrated wind power generation system is realized in this invention, which is totally different than the prior art design, that is, it can really enhance the entire utilization value, moreover, since it is not published in the journal or used in public, hence, the requirements for an invention are met, and an application is thus submitted.

Although the present invention is disclosed through a better embodiment as above, yet it is not used to limit the present invention, anyone that is familiar with this art, without deviating the spirit and scope of the present invention, can make any kinds of change, revision and finishing; therefore, the protection scope of the present invention should be based on the scope as defined by the following attached “what is claimed”.

What is claimed is:

1. A parallel-connected matrix integrated wind power generation system, which comprises of:
a plurality of Savonius wind turbines for form an integrated wind turbine, and the plurality of Savonius wind turbines are arranged in parallel-connected way so as to collect the wind force to generate energy;
a distance positioning component among wind turbines is connected to those plurality of Savonius wind turbines so that fixed distances are maintained among those plurality of Savonius wind turbines; and
a phase positioning component among wind turbines is connected to those plurality of Savonius wind turbines so as to fix the phase angle differences of those plurality of Savonius wind turbines, meanwhile, those phase positioning components among wind turbines are used to transfer the energy generated by the rotation of those plurality of Savonius wind turbines to a power generation machine set.

2. The parallel-connected matrix integrated wind power generation system of claim 1 wherein the distance positioning component among those wind turbines is a lever, which is connected through bearing to the plurality of Savonius wind turbines.

3. The parallel-connected matrix integrated wind power generation system of claim 1 wherein the distance positioning component among wind turbines is a frame, which is connected through bearing to the axis of those plurality of Savonius wind turbine.

4. The parallel-connected matrix integrated wind power generation system of claim 1 wherein it further includes a support component, and the support component is connected to wind turbine distance positioning component in non-parallel way soas to provide support and fixing action.

5. The parallel-connected matrix integrated wind power generation system of claim 4 wherein the support component is a lever.

6. The parallel-connected matrix integrated wind power generation system of claim 4 wherein the support component is a frame.

7. The parallel-connected matrix integrated wind power generation system of claim 4 wherein the support component is a steel rope.

8. The parallel-connected matrix integrated wind power generation system of claim 4 wherein the support component is a pillar.

9. The parallel-connected matrix integrated wind power generation system of claim 1 wherein the Savonius wind turbine is two-bladed, three-bladed or multi-bladed type.

10. The parallel-connected matrix integrated wind power generation system of claim 1 wherein the phase positioning component among wind turbines is gear set.

11. The parallel-connected matrix integrated wind power generation system of claim 1 wherein the phase positioning component among those wind turbines is a transmission axis.

12. The parallel-connected matrix integrated wind power generation system of claim 1 wherein the phase positioning component among those wind turbines is a transmission chain.

13. The parallel-connected matrix integrated wind power generation system of claim 1 wherein each of the Savonius wind turbine further comprises of at least one flow-guiding plate installed among the blades of the Savonius wind turbine.

14. The parallel-connected matrix integrated wind power generation system of claim 13 wherein the flow-guiding plate is of fluid dynamic shape.

15. The parallel-connected matrix integrated wind power generation system of claim 14 wherein the flow-guiding plateis of Clark Y improvement form.

16. The parallel-connected matrix integrated wind power generation system of claim 1 wherein it further includes a power generation machine room, and the power generation machine room comprises of a control module and a plurality of power generation machine set, meanwhile, the energy collected by those plurality of Savonius wind turbinee is transferred to the power generation machine room, and the control module then follow the wind kinetic energy to control the operation of those plurality of power generation machine set.
